(19) United States
(12) Patent Application Publication
(10) Pub. No.: US 2026/0166793 A1
(43) Pub. Date: Jun. 18, 2026

(54) MOLDING SUPPORTING DEVICE AND MOLDING SUPPORTING SYSTEM

(71) Applicant: SUMITOMO HEAVY INDUSTRIES, LTD., Tokyo (JP)

(72) Inventors: Tomosuke KADOONO, Chiba-shi (JP); Atsuro TAMURA, Chiba-shi (JP); Daigo HOTTA, Chiba-shi (JP)

(21) Appl. No.: 19/306,860

(22) Filed: Aug. 21, 2025

(30) Foreign Application Priority Data
Dec. 18, 2024 (JP) 2024-221997

(51) Int. Cl. B29C 45/76

(52) U.S. Cl. CPC B29C 45/766; B29C 2045/7606; B29C 2945/76913

(57) ABSTRACT

The present invention relates to a molding supporting device which includes: an acquisition unit that acquires an operation status of an operation currently performed by a worker on the molding supporting device; and an output unit that outputs advice information that provides advice according to the operation status acquired by the acquisition unit.

### CROSS-REFERENCE TO RELATED APPLICATIONS

This application claims priority to Japanese Patent Application No. 2024-221997, filed on December 18, 2024, which is incorporated by reference herein in its entirety.

### BACKGROUND

### Technical Field

A certain embodiment of the present invention relates to a molding supporting device and a molding supporting system.

### Description of Related Art

The related art discloses a display method of a setting screen. In this display method, a predetermined setting screen is formed on a display part based on an operation of an operation unit performed by an operator. In addition, in this display method, in a case where a predetermined setting item of molding conditions is selected by the operator and a confirmation operation element is pressed, a guidance screen is formed in a part of a region of the setting screen corresponding to the setting item. Further, in this display method, guidance information is read out from a recording unit and is displayed on the guidance screen.

The related art discloses a molding condition setting method of an injection molding machine that sets molding conditions in the injection molding machine. In this molding condition setting method, reference pellet data is set in advance for one or more pieces of pellet data that differ depending on the usage period of the same type of pellet. In addition, in this molding condition setting method, the usage pellet data is collected in a case where the same type of pellet is used. Further, in this molding condition setting method, the usage pellet data and the reference pellet data are compared with each other, and the molding condition is corrected by using the comparison result data obtained from the comparison result.

The related art discloses a setting supporting method for an injection molding machine. As a basic concept of the setting supporting method, it is described that resin material data Dr … relating to a resin decomposition ratio Sx with respect to a temperature Ht, which corresponds to the type of the resin material, is set in advance as a database in a molding machine controller.

### SUMMARY

According to an embodiment of the present invention, there is provided a molding supporting device including an acquisition unit that acquires an operation status of an operation currently performed by a worker on the molding supporting device, and an output unit that outputs advice information that provides advice according to the operation status acquired by the acquisition unit.

In addition, according to an embodiment of the present invention, there is provided a molding supporting device including an acquisition unit that acquires advice information that provides advice according to an operation status of an operation currently performed by a worker on the molding supporting device, and an output unit that outputs the advice information acquired by the acquisition unit.

Further, according to an embodiment of the present invention, there is provided a molding supporting system including an acquisition unit that acquires an operation status of an operation currently performed by a worker on a molding supporting device, and an output unit that outputs advice information that provides advice according to the operation status acquired by the acquisition unit.

### BRIEF DESCRIPTION OF THE DRAWINGS

FIG. 1 is a view showing a configuration of an injection molding machine to which the present embodiment is applied.

FIG. 2 is a view showing a configuration of a control device.

FIG. 3 is a view showing a configuration of a data processing device.

FIG. 4 is a view showing a configuration of an information providing device.

FIG. 5 is a view showing a hardware configuration example of a computer that realizes the control device, the data processing device, and the information providing device.

FIG. 6 is a view showing an example of a flow of information providing processing performed by the information providing device.

FIGS. 7A and 7B are views showing a screen displayed on a display unit.

FIGS. 8A and 8B are views showing a screen displayed on the display unit.

FIGS. 9A and 9B are views showing a screen displayed on the display unit.

### DETAILED DESCRIPTION

For example, in a configuration in which the same advice is provided to all workers, there may be workers who do not need advice or workers who receive insufficient advice. That is, in a configuration in which the same advice is provided to all workers, it is not possible to increase a likelihood that advice that is considered to be desired by the worker is provided to the worker.

It is desirable to increase a likelihood that advice that is considered to be desired by the worker is provided to the worker.

The operation status may include a status related to a procedure of the operation and a status related to a time of the operation.

The status related to the procedure of the operation may include a status in which a specific operation is repeatedly performed and a status in which an order of a specific operation and another specific operation is incorrect.

In a case where the status related to the procedure of the operation is the status in which the specific operation is repeatedly performed, the output unit may output the advice information related to another operation other than the specific operation. In this case, in a case where the specific operation is an operation of changing a setting value of a specific setting item, the advice information may be information related to existence of another setting item other than the specific setting item. In addition, in a case where the specific operation is an operation of changing a setting value of a specific setting item, the advice information may be information related to an effect of changing a setting value of another setting item other than the specific setting item.

The status related to the time of the operation may include a status in which a time required or taken for a specific operation exceeds a reference and a status in which a time required from a specific operation to another specific operation exceeds the reference.

In a case where the status related to the time of the operation is the status in which the time required or taken for the specific operation exceeds the reference, the output unit may output the advice information related to a defect of the specific operation. In this case, in a case where the specific operation is an operation of setting a setting value of a specific setting item, the advice information may be information related to an error in a setting procedure of the setting value of the specific setting item or an excess or deficiency of a setting item in the specific setting item.

The output unit may output the advice information that is added value for the worker in a case where the operation status is not a status in which a specific operation is repeatedly performed and is not a status in which a time required for the specific operation exceeds a reference. In this case, the advice information may be information related to a function not used by the worker or an operation that is effective among operations performed by the worker.

The specific operation may include an operation of changing a setting value of a specific setting item, setup work or work constituting the setup work, and work performed between molding cycles in a case where a defective product occurs.

In a case where the operation status is a status presumed to indicate hesitation of the worker, the output unit may output the advice information for eliminating the hesitation.

The acquisition unit may further acquire an operation content of the operation currently performed by the worker on the molding supporting device, and the output unit may output the advice information that further provides advice according to the operation content acquired by the acquisition unit. In this case, the output unit may output the operation content or the advice information for a phenomenon currently occurring which is estimated from the operation content.

Hereinafter, an embodiment of the present invention will be described in detail with reference to the accompanying drawings.

### DEVICE CONFIGURATION

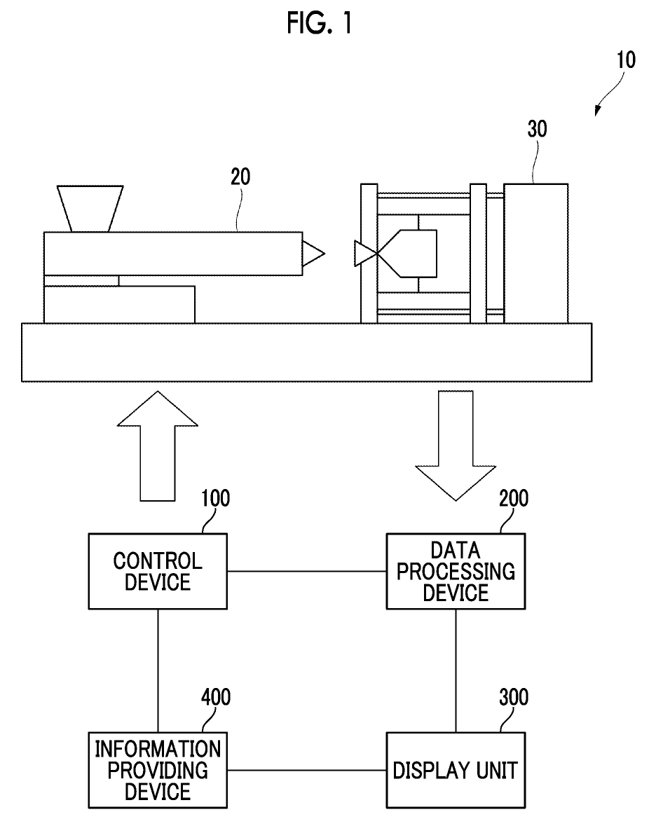

FIG. 1 is a view showing a configuration of an injection molding machine 10 to which the present embodiment is applied. The injection molding machine 10 includes an injection unit 20, a mold clamping unit 30, a control device 100, a data processing device 200, a display unit 300, and an information providing device 400. In the following description, a direction from the injection unit 20 toward the mold clamping unit 30 may be referred to as a front. The injection molding machine 10 is an example of a molding machine.

The injection unit 20 is configured with a cylinder that heats a molding material, a screw that is rotatable in the cylinder and that is capable of advancing and retreating in an axial direction, a rotary motor that drives the screw in a rotation direction, a motor that drives the screw in the axial direction, and the like. The molding material is, for example, a resin. The injection unit 20 injects the molding material that is heated and liquefied in the cylinder by advancing the screw in a front direction while rotating the screw, and fills a mold of the mold clamping unit 30 disposed in front of the injection unit 20. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 includes the mold, a clamping mechanism that clamps the mold, a motor that drives the clamping mechanism, and the like. The mold clamping unit 30 closes the mold to receive the molding material injected from the injection unit 20 into an inside of the mold. In this case, the mold clamping unit 30 clamps the mold by means of a clamping mechanism such that the mold does not open due to the filling of the molding material (mold clamping). A molding product is produced by solidifying the molding material filled in the mold. After that, the mold clamping unit 30 opens the mold and ejects the produced molding product. The mold clamping unit 30 performs, for example, a mold closing process, a pressure increasing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation to input commands or data to the control device 100 and the data processing device 200. In addition, the display unit 300 displays advice information provided to a user. The information providing device 400 is a device that determines the advice information to be provided to the user of the injection molding machine 10 and causes the display unit 300 to display the advice information. The information of the advice may be displayed on a display screen other than the display unit 300. Display screens other than the display unit 300 include a display screen of a terminal device such as a PC, a smartphone, or a tablet connected to the injection molding machine 10 via a communication line. The information providing device 400 is an example of a molding supporting device.

### CONFIGURATION OF CONTROL DEVICE 100

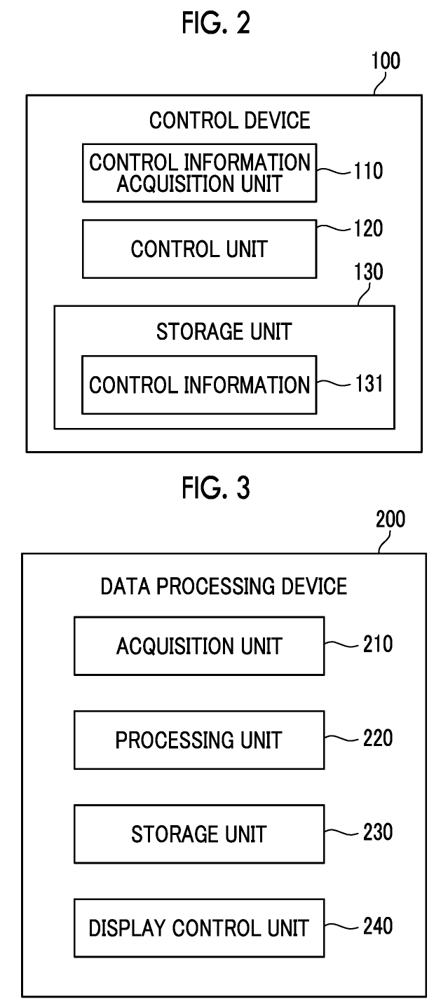

FIG. 2 is a view showing a configuration of the control device 100. The control device 100 controls operations of the injection unit 20 and the mold clamping unit 30. The control device 100 is realized by, for example, a computer. The control device 100 includes a control information acquisition unit 110, a control unit 120, and a storage unit 130. The control device 100 controls the injection unit 20 and the mold clamping unit 30 to repeatedly perform a process related to the manufacturing of the molding product, thereby repeatedly manufacturing the molding product. The process related to the manufacturing of the molding product includes a plasticizing process, a mold closing process, a pressure increasing process, a mold clamping process, a filling process, a pressure holding process, a cooling process, a depressurizing process, a mold opening process, an ejection process, and the like. Hereinafter, these processes related to the manufacturing may be collectively referred to as a "manufacturing process". In addition, a series of operations for obtaining a molding product, for example, an operation from the start of the plasticizing process in the above manufacturing process to the start of the next plasticizing process is referred to as a "shot", a "molding cycle", or the like. In addition, each of the above processes for manufacturing the molding product is merely an example. For example, as a process executed in one shot, another process not included in the above may be included.

The control information acquisition unit 110 acquires control information used to control the injection unit 20 and the mold clamping unit 30. The control information is a condition set by the user, and, for example, is input by the user using an input unit (not shown). For example, the control information includes molding conditions such as a resin temperature, a mold temperature (a cylinder temperature), an injection pressure holding time, a metering value, a V-P switching position, a pressure holding, an injection speed (a filling speed), a screw rotation speed, a screw back pressure, and a mold clamping force. A plurality of combinations of these molding conditions are determined depending on the molding product and the mold. Hereinafter, the combination data of the molding conditions will be also referred to as a molding condition data set. The control information acquisition unit 110 stores the acquired control information in the storage unit 130 as the molding condition data set.

The control unit 120 controls the injection unit 20 and the mold clamping unit 30 by using the above molding condition data set, and performs a process related to the manufacturing (shot) of the molding product including each of the above processes. The control unit 120 reads a molding condition data set corresponding to the molding product to be manufactured from the storage unit 130, for example, in a case where the manufacturing of the molding product starts. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process matches a setting value of the molding condition data set. In addition, the control unit 120 may cause the display unit 300 to display the molding condition data set read from the storage unit 130. The user may refer to the data of the molding conditions displayed on the display unit 300 and may perform an operation such as correcting a value as necessary.

The storage unit 130 holds control information 131 acquired by the control information acquisition unit 110. The molding condition data set included in the control information 131 is prepared in association with a molding product to be manufactured and the mold. The storage unit 130 holds a molding condition data set for each molding product to be manufactured and each mold. In addition, although not shown, the storage unit 130 holds a program for the control unit 120 to control the injection unit 20 and the mold clamping unit 30. As will be described in detail later, the function of the control unit 120 is realized by a processor of the control device 100 reading and executing the program held in the storage unit 130.

### CONFIGURATION OF DATA PROCESSING DEVICE 200

FIG. 3 is a view showing a configuration of the data processing device 200. The data processing device 200 acquires and processes data obtained as the injection unit 20 and the mold clamping unit 30 execute operations in the process related to the manufacturing of the molding product. The data processing device 200 is realized by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by the sensors and the detectors (hereinafter, referred to as "acquisition data") is information representing a molding result of the injection unit 20 and the mold clamping unit 30, and is used for quality control of the molding product. Specifically, for example, the weight of the molding product, the dimensions of the molding product, the mold internal pressure, the minimum cushion position, and the feature values of the waveform of the filling pressure are included. The acquisition data is an actual value obtained in a manufacturing process of the molding product. The acquisition unit 210 receives the acquisition data transmitted from the sensor and the detector and stores the acquisition data in the storage unit 230.

The processing unit 220 processes the acquisition data stored in the storage unit 230. Specifically, the processing unit 220 performs processing of extracting a representative value of the acquisition data in each process and processing of generating time series data in which the acquisition data in each process is arranged in chronological order. In extracting the representative value, the processing unit 220 performs statistical processing such as calculating an average value, specifying a range of values, and specifying a maximum value or a minimum value on the acquisition data.

The storage unit 230 holds the representative value, the time series data, the statistical data, and the like, processed by the processing unit 220. The data is associated with, for example, the original acquisition data. Specifically, the data may be stored in a data file of the original acquisition data corresponding to the data. In addition, the data file in which data is stored may be associated with the data file of the original data. Accordingly, each piece of data generated by the processing unit 220 is also held in association with the molding product to be manufactured and the mold in the shot in which the original acquisition data is obtained. As the data format of the data file held in the storage unit 230, for example, comma-separated values (CSV), Extensible Markup Language (XML), JavaScript Object Notation (JSON), or the like can be used.

In addition, although not shown, the storage unit 230 holds a program for the processing unit 220 to execute data processing. As will be described in detail later, the processor of the data processing device 200 reads and executes the program held in the storage unit 230, so that functions of the processing unit 220 are realized.

The display control unit 240 causes the display unit 300 to display the acquisition data and the data of the processing result by the processing unit 220. The data to be displayed includes setting information in the control information used by the control device 100 to control the injection unit 20 and the mold clamping unit 30. The setting information (setting value) can be acquired from the control device 100. The display control unit 240 acquires the data from the storage unit 230 and the storage unit 130 of the control device 100 and causes the data to be displayed on the display unit 300.

### CONFIGURATION OF INFORMATION PROVIDING DEVICE 400

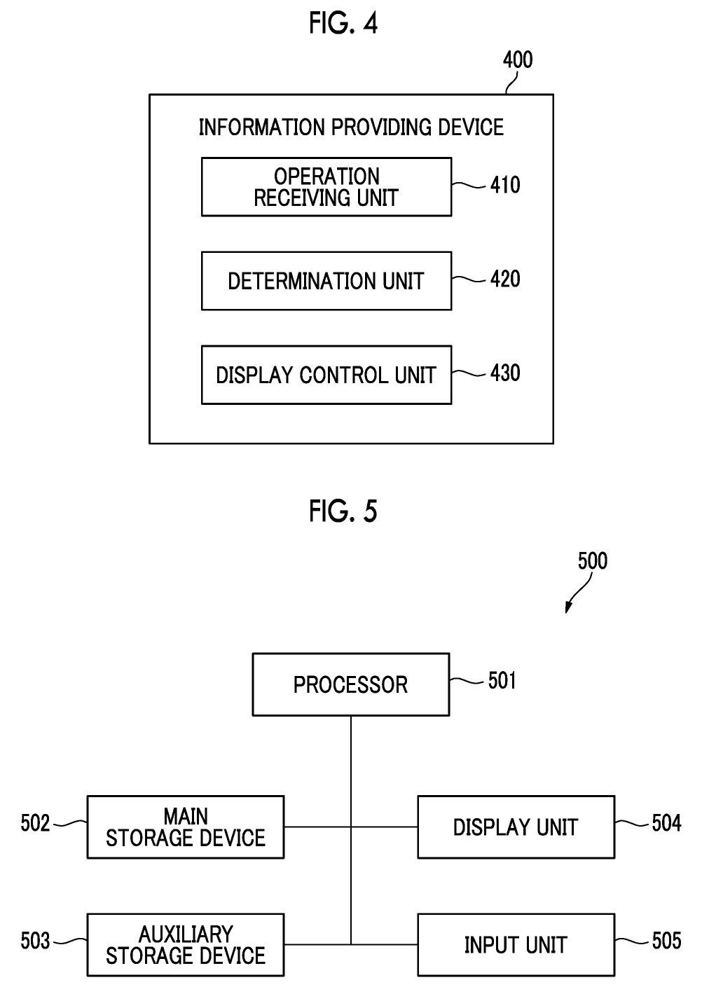

FIG. 4 is a view showing a configuration of the information providing device 400. The information providing device 400 includes an operation receiving unit 410, a determination unit 420, and a display control unit 430.

The operation receiving unit 410 receives an operation on the control device 100 on an operation screen displayed on the display unit 300. Here, the operation on the control device 100 is an operation performed on the control device 100 by a user (molding worker) in order to perform the molding work using the injection unit 20 and the mold clamping unit 30. Hereinafter, the "molding work" is simply referred to as "work", and the "molding worker" is simply referred to as "worker".

The determination unit 420 determines an operation status of the operation received by the operation receiving unit 410. In this case, the determination unit 420 is an example of an acquisition unit that acquires the operation status of the operation currently performed by the worker on the device itself.

The operation status includes a status related to a procedure of the operation and a status related to a time of the operation.

The status related to the procedure of the operation includes a status in which the worker is repeating the same operation. In other words, this status is a status in which the worker performs the same operation beyond the assumed number of times. The same operation is, for example, an operation of repeatedly changing a setting value of the same setting item. The operation of repeatedly changing the setting value of the same setting item may be an operation of repeatedly changing a setting value of one setting item. Alternatively, the operation of repeatedly changing the setting value of the same setting item may be an operation of repeatedly changing setting values across a plurality of setting items. In this case, the determination unit 420 is an example of an acquisition unit that acquires an operation status in which a specific operation is repeatedly performed. In addition, the determination unit 420 is also an example of an acquisition unit that acquires an operation status in which an operation of changing a setting value of a specific setting item is repeated.

In addition, the status related to the procedure of the operation includes a status in which the order of the operations is incorrect.

The status related to the time of the operation includes a status in which a time required or taken by the worker to perform the same operation exceeds a reference. In other words, this status is a status in which the worker performs the same operation beyond the assumed time. The same operation may be, for example, an operation of setting a setting value in some setting items. In this case, the determination unit 420 is an example of an acquisition unit that acquires an operation status in which a time required or taken for a specific operation exceeds the reference. In addition, the determination unit 420 is also an example of an acquisition unit that acquires an operation status in which a time required or taken for setting a setting value in a specific setting item exceeds the reference.

In addition, the status related to the time of the operation may also include a status in which the time required from a specific operation to another specific operation exceeds the reference.

The operation status includes a status in which the worker does not repeat the same operation and the time required for the worker to perform the same operation does not exceed the reference. In other words, this status is a status in which the worker does not perform the same operation beyond the assumed number of times and the worker does not perform the same operation beyond the assumed time. In this case, the determination unit 420 is an example of an acquisition unit that acquires the operation status in which a specific operation is not repeatedly performed and the time required for the specific operation does not exceed the reference.

In addition, the determination unit 420 determines an operation content of an operation received by the operation receiving unit 410. In this case, the determination unit 420 is an example of the acquisition unit that further acquires the operation content of the operation currently performed by the worker on the device itself.

The display control unit 430 causes the display unit 300 to display advice information for providing advice according to the operation status determined by the determination unit 420 for the operation received by the operation receiving unit 410. In this way, the display control unit 430 notifies the worker of the advice information. The display control unit 430 is an example of an output unit that outputs advice information that provides advice according to the operation status acquired by the acquisition unit.

Here, the advice information includes advice information in a case where the worker repeats the same operation. The same operation is, for example, an operation of repeatedly changing a setting value of the same setting item. The operation of repeatedly changing the setting value of the same setting item may be an operation of repeatedly changing a setting value of one setting item. Alternatively, the operation of repeatedly changing the setting value of the same setting item may be an operation of repeatedly changing setting values across a plurality of setting items.

The advice information in that case includes advice information for advising whether or not other operations have been forgotten. For example, the advice information for advising whether or not other operations have been forgotten includes advice information for advising whether or not the other setting items have been forgotten. For example, it is assumed that a sink mark occurs in a molding product, and a worker tries to improve a defect phenomenon by changing the pressure holding. Since increasing the pressure holding causes burrs to occur, it is assumed that the worker is repeatedly increasing and decreasing the pressure holding setting. In such a status, the display control unit 430 also provides advice so as to draw attention to other setting items that have not been changed so far, which affect the sink mark. Examples of such setting items include pressure holding time, cooling time, mold temperature, cylinder temperature, and the like. In this case, in a case where the operation status is a status in which the specific operation is repeatedly performed, the display control unit 430 is an example of an output unit that outputs advice information related to another operation other than the specific operation. In addition, in a case where the operation status is a status in which an operation of changing a setting value of the specific setting item is repeated, the display control unit 430 is an example of an output unit that outputs advice information related to existence of another setting item other than the specific setting item.

The advice information in that case includes advice information for advising on an effect that appears through another operation. For example, the advice information for advising on the effect that appears through the other operation is advice information for advising on an effect that appears by changing the setting value of the other setting item. For example, it is assumed that a sink mark occurs in a molding product, and a worker tries to improve a defect phenomenon by changing the mold clamping force. In such a status, the display control unit 430 provides advice on the setting item and the method of changing the setting item and the result of the change. Examples of the setting item and the method of changing the setting item and the result of the change include "increasing the pressure holding time improves sink marks", "shortening the pressure holding time worsens sink marks", and "the mold clamping force has a low degree of influence on sink marks". In this case, in a case where the operation status is a status in which the specific operation is repeatedly performed, the display control unit 430 is an example of an output unit that outputs advice information related to another operation other than the specific operation. In addition, in a case where the operation status is a status in which an operation of changing a setting value of the specific setting item is repeated, the display control unit 430 is an example of an output unit that outputs advice information related to an effect of changing a setting value of another setting item other than the specific setting item.

The advice information also includes advice information in a case where the time required for the worker to perform the same operation exceeds the reference. The same operation may be, for example, an operation of setting a setting value in some setting items.

The advice information in that case includes advice information for advising whether or not there is a defect in the operation. For example, the advice information for advising whether or not there is a defect in the operation is advice information for advising whether or not the setting procedure is correct or whether or not there is an excess or deficiency in the setting item. For example, it is assumed that the worker takes time to recover from a short stoppage and performs the operation beyond the assumed time. In such a status, the display control unit 430 provides advice that gives the user awareness that the recovery is taking time. Examples of the information given as such awareness include a flowchart of whether or not there is an error in the recovery procedure, the executed content, the unoperated item, the excessively set setting item, and the like. In this case, in a case where the operation status is a status in which the time required for the specific operation exceeds the reference, the display control unit 430 is an example of an output unit that outputs advice information related to the defect of the specific operation. In a case where the operation status is a status in which the time required for the operation of setting the setting value of the specific setting item exceeds a reference, the display control unit 430 is also an example of an output unit that outputs advice information related to an error in a setting procedure of the setting value of the specific setting item or an excess or deficiency of the setting item in the specific setting item.

The advice information includes advice information in a case where the worker does not repeat the same operation and the time required for the worker to perform the same operation does not exceed the reference.

The advice information in that case includes advice information that is added value for the worker. For example, the advice information that is added value for the worker is advice information for advising on the operation method and the effect of the function that leads to high added value for the worker. For example, a sink mark occurs in a molding product, and a worker (having a high skill level) extends the pressure holding time to improve the sink mark. In such a status, the display control unit 430 makes a proposal that leads to high added value, such as energy saving molding by using energy saving pressure holding. Alternatively, the display control unit 430 makes a proposal that leads to high added value such as "the power consumption per shot can be reduced in a case where the energy saving pressure holding is turned on". In addition, the advice information that is added value for the worker is, for example, the advice information for advising on the operation that is effective among the operations performed by the worker. For example, it is assumed that the worker (having a high skill level) completes the recovery from the short stoppage in a short time. In such a status, the display control unit 430 makes a proposal that further enhances knowledge, such as presenting a page or an item that is effective in the prior information collection. In this case, the display control unit 430 is an example of an output unit that outputs the advice information that is added value for the worker in a case where the operation status is not a status in which a specific operation is repeatedly performed and is not a status in which a time required for the specific operation exceeds a reference. In addition, in a case where the operation status is not a status in which a specific operation is repeatedly performed and is not a status in which a time required for the specific operation exceeds a reference, the display control unit 430 is also an example of an output unit that outputs advice information related to a function that is not used by the worker or an operation that is effective among operations performed by the worker.

The display control unit 430 also causes the display unit 300 to display advice information for providing advice according to the operation content determined by the determination unit 420 for the operation received by the operation receiving unit 410. In this way, the display control unit 430 notifies the worker of the advice information. The presentation of the page or the item that is effective in the above prior information collection is also one example of such advice information. Further, the display control unit 430 may provide advice on the operation content of the worker as the advice information. Alternatively, the display control unit 430 may estimate a phenomenon that is occurring based on the operation content of the worker, and may provide advice on the phenomenon as the advice information. The estimation of the phenomenon that is occurring may be performed by using artificial intelligence (AI), or may be performed based on a rule base. In this case, the display control unit 430 is an example of an output unit that outputs advice information for further providing advice according to the operation content acquired by the acquisition unit. In addition, the display control unit 430 is an example of an output unit that outputs the operation content or the advice information for a phenomenon currently occurring which is estimated from the operation content.

### HARDWARE CONFIGURATION OF COMPUTER REALIZING CONTROL DEVICE 100, DATA PROCESSING DEVICE 200, AND INFORMATION PROVIDING DEVICE 400

FIG. 5 is a view showing a hardware configuration example of a computer 500 that realizes the control device 100, the data processing device 200, and the information providing device 400. The computer 500 shown in FIG. 5 includes a processor 501 serving as a calculation means, and a main storage device (main memory) 502 and an auxiliary storage device 503 serving as storage means. As the processor 501, for example, various calculation circuits such as a central processing unit (CPU), a graphics processing unit (GPU), an application-specific integrated circuit (ASIC), and a field-programmable gate array (FPGA) are used. The processor 501 reads a program stored in the auxiliary storage device 503 into the main storage device 502 and executes the program. For example, a random-access memory (RAM) is used as the main storage device 502. For example, a magnetic disk device, a solid-state drive (SSD), or the like is used as the auxiliary storage device 503.

In addition, the computer 500 includes a display unit (display) 504 and an input unit 505 through which a user performs an input operation. For example, a keyboard, a mouse, or the like is used as the input unit 505. Further, a touch panel configured integrally with the display unit 504 may be used as the input unit 505. The display unit 504 may be realized by the display unit 300 shown in FIG. 1. In addition, a configuration of the computer 500 shown in FIG. 5 is merely an example, and the computer 500 used in the present embodiment is not limited to the configuration example of FIG. 5. For example, the configuration may include a non-volatile memory such as a flash memory, or a read-only memory (ROM) may be provided as the storage device.

In a case where the control device 100 is realized by the computer shown in FIG. 5, the control information acquisition unit 110 is realized by, for example, the processor 501 that reads and executes the program and the input unit 505. The function of the control unit 120 is realized, for example, by the processor 501 reading and executing the program. The storage unit 130 is realized by, for example, the auxiliary storage device 503.

In a case where the data processing device 200 is realized by the computer shown in FIG. 5, the functions of the acquisition unit 210 and the processing unit 220 are realized by, for example, the processor 501 reading and executing the program. The storage unit 230 is realized by, for example, the auxiliary storage device 503. The display control unit 240 is realized by the processor 501 that reads and executes the program.

In a case where the information providing device 400 is realized by the computer 500 shown in FIG. 5, the functions of the operation receiving unit 410 and the determination unit 420 are realized by, for example, the processor 501 reading and executing the program. The display control unit 430 is realized by the processor 501 that reads and executes the program.

### INFORMATION PROVIDING PROCESSING

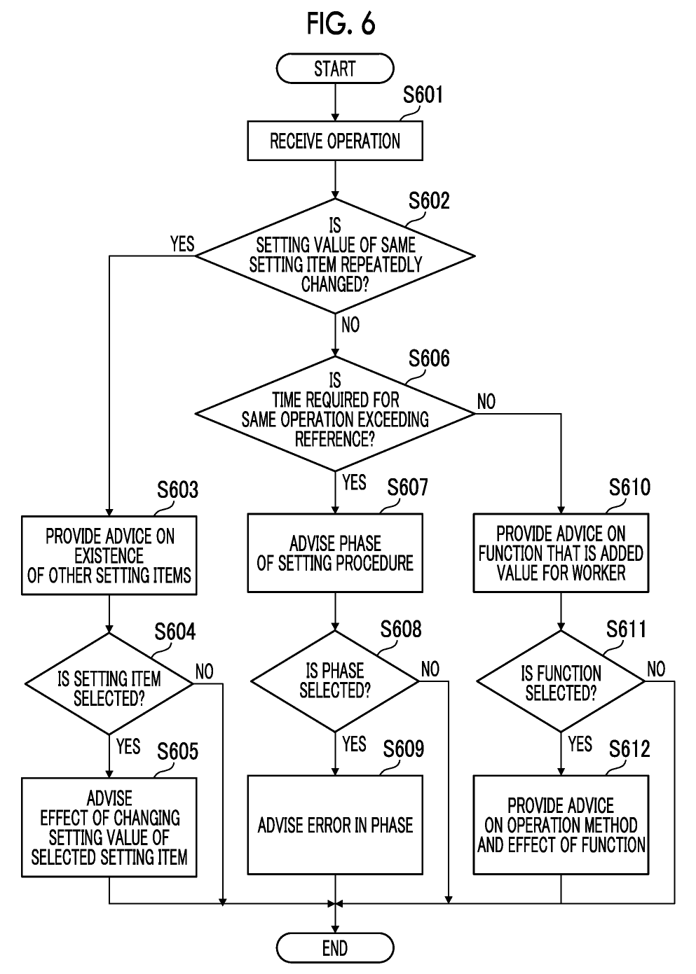

FIG. 6 is a view showing an example of a flow of information providing processing performed by the information providing device 400.

In FIG. 6, first, the operation receiving unit 410 receives an operation of the worker (Step S601). Specifically, the operation receiving unit 410 receives the operation of the worker in response to an operation of the worker on an operation screen displayed on the display unit 300. Here, an operation of setting a setting value in a setting item will be described as an example of the operation.

Next, the determination unit 420 determines, as the operation status of the operation received in Step S601, whether or not the setting value of the same setting item is repeatedly changed (Step S602). Here, the same setting item may be one setting item or may be a plurality of setting items.

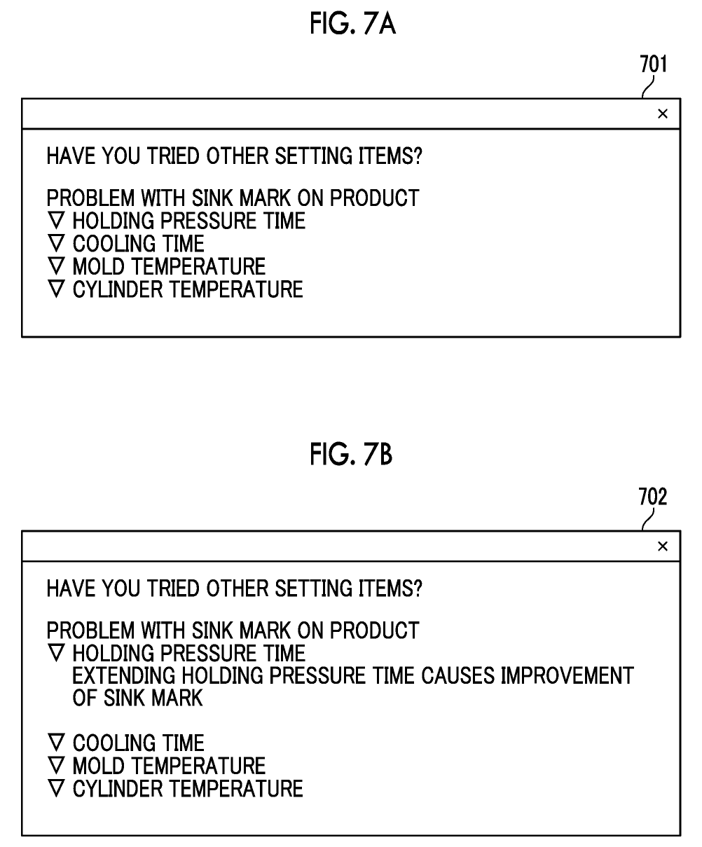

A case where it is determined in Step S602 that the worker repeatedly changes the setting value of the same setting item will be described. In that case, first, the display control unit 430 provides advice on the existence of the other setting items (Step S603). Specifically, the display control unit 430 causes the display unit 300 to display advice information for advising whether or not the other setting items have been forgotten. FIG. 7A is a view showing a screen 701 displayed on the display unit 300 in this case. On the screen 701, "pressure holding time", "cooling time", "mold temperature", and "cylinder temperature" are shown as setting items for which a change in the setting value should be tried when a sink mark occurs in the product.

Next, the display control unit 430 determines whether or not any setting item is selected among the setting items displayed in Step S603 (Step S604). Specifically, the display control unit 430 determines whether or not the worker has selected any of the setting items on the screen displayed on the display unit 300 in Step S603.

In a case where it is determined in Step S604 that any of the setting items is selected, the display control unit 430 advises on an effect of changing the setting value of the selected setting item (Step S605). Specifically, the display control unit 430 causes the display unit 300 to display advice information advising on a method of changing the selected setting item and the result thereof. FIG. 7B is a view showing a screen 702 displayed on the display unit 300 in this case. The screen 702 is a screen displayed by selecting the setting item "pressure holding time" on the screen 701. On the screen 702, as the effect of changing the setting value of the selected setting item "pressure holding time", it is indicated that extending the pressure holding time causes the improvement of the sink marks.

After that, the information providing device 400 ends the processing.

In a case where it is determined in Step S604 that no setting item is selected, the information providing device 400 ends the processing without advising on the effect of the setting value of the setting item.

On the other hand, a case where it is not determined in Step S602 that the worker repeatedly changes the setting value of the same setting item will be described. In that case, the determination unit 420 determines whether or not a time required for the worker to perform the same operation exceeds a reference as the operation status of the operation received in Step S601 (Step S606).

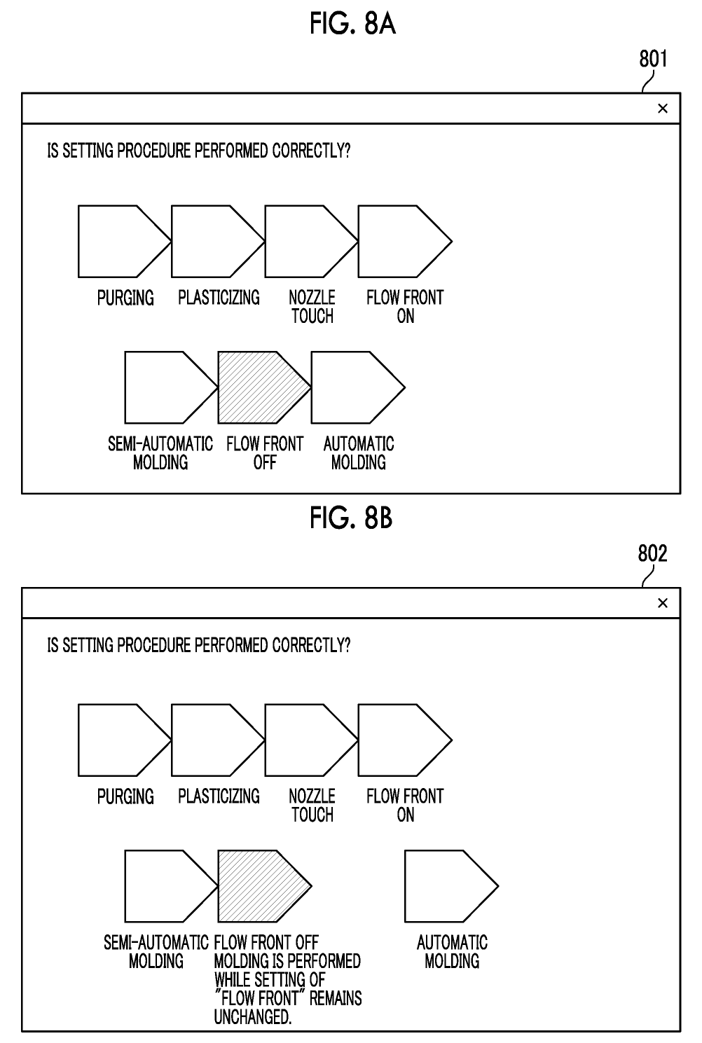

A case where it is determined in Step S606 that the time required for the worker to perform the same operation exceeds the reference will be described. In that case, first, the display control unit 430 provides advice on the phase of a setting procedure (Step S607). Specifically, the display control unit 430 causes the display unit 300 to display advice information for advising whether or not the phase of the setting procedure is correct. The display control unit 430 may provide advice on whether or not there is an excess or deficiency of the setting items. However, here, a case where the display control unit 430 provides advice on the phase of the setting procedure will be described as an example. FIG. 8A is a view showing a screen 801 displayed on the display unit 300 in this case. In the screen 801, "purging", "plasticizing", "nozzle touch", "flow front on", "semi-automatic molding", "flow front off", and "automatic molding" are shown as the phases of the setting procedure. At that time, the phase "flow front off" is indicated as including an error by being shown differently from other phases, such as by diagonal hatching.

Next, the display control unit 430 determines whether or not any phase is selected among the phases displayed in Step S607 (Step S608). Specifically, the display control unit 430 determines whether or not the worker has selected any of the phases on the screen displayed on the display unit 300 in Step S607.

In a case where it is determined that any of the phases is selected in Step S608, the display control unit 430 provides advice on an error in the selected phase (Step S609). Specifically, the display control unit 430 causes the display unit 300 to display advice information for advising on the status of the error in the selected phase. FIG. 8B is a view showing a screen 802 displayed on the display unit 300 in this case. The screen 802 is a screen displayed by selecting the phase "flow front off" including an error on the screen 801. On the screen 802, it is shown that, as an error of the selected phase "flow front off", molding is performed while the setting of the flow front remains applied.

After that, the information providing device 400 ends the processing.

In a case where it is determined in Step S608 that no phase is selected, the information providing device 400 ends the processing without advising on the phase error.

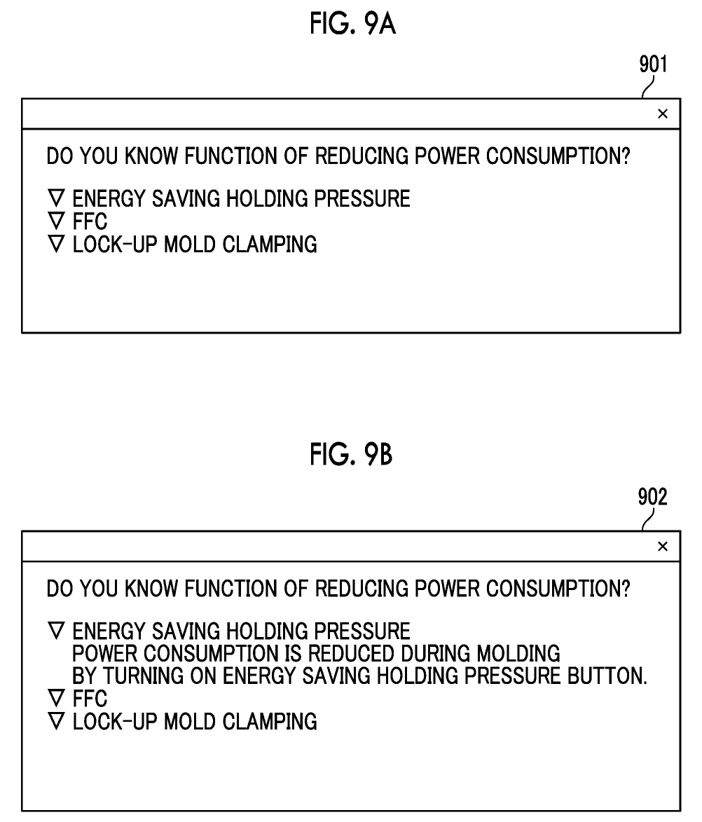

On the other hand, a case where it is determined in Step S606 that the time required for the worker to perform the same operation does not exceed the reference will be described. In that case, first, the display control unit 430 provides advice on a function that is added value for the worker (Step S610). Specifically, the display control unit 430 causes the display unit 300 to display advice information for advising on a function that leads to high added value for the worker. The display control unit 430 may advise the worker on an effective operation, but here, a case where the display control unit 430 provides advice on a function that is added value for the worker will be described as an example. FIG. 9A is a view showing a screen 901 displayed on the display unit 300 in this case. On the screen 901, "energy saving pressure holding", "flow front control (FFC)", and "lock-up mold clamping" are shown as functions that are added value for the worker.

Next, the display control unit 430 determines whether or not any of the functions displayed in Step S610 is selected (Step S611). Specifically, the display control unit 430 determines whether or not the worker has selected any of the functions on the screen displayed on the display unit 300 in Step S610.

In a case where it is determined that any of the functions is selected in Step S611, the display control unit 430 provides advice on the operation method and the effect of the selected function (Step S612). Specifically, the display control unit 430 causes the display unit 300 to display advice information advising on the operation method and the effect of the selected function. FIG. 9B is a view showing a screen 902 displayed on the display unit 300 in this case. The screen 902 is a screen that is displayed by selecting the function "energy saving pressure holding" on the screen 901. On the screen 902, as the operation method and the effect of the selected function "energy saving pressure holding", it is shown that the power consumption during molding is reduced by turning on an energy saving pressure holding button.

After that, the information providing device 400 ends the processing.

In a case where it is determined in Step S611 that no function is selected, the information providing device 400 ends the processing without advising on the operation method and the effect of the function.

In FIG. 6, the determination unit 420 determines the operation status of the operation of the worker, and the display control unit 430 displays the advice information according to the operation status. However, the present invention is not limited thereto. The determination unit 420 may determine an operation content of the operation of the worker, and the display control unit 430 may display the advice information according to the operation content.

### SUMMARY

In the present embodiment, the advice that the worker is likely to want is provided from the injection molding machine 10 side by monitoring the operation itself currently performed by the worker. Accordingly, it is possible to expect a reduction in the man-hours required for the work using the molding machine.

In addition, in the present embodiment, a proposal is made so as to lead to higher added value depending on the operation status or the operation content of the operation of the worker. Accordingly, it is possible to expect an improvement in the product value on the worker side.

Further, in the present embodiment, the advice that the worker is likely to want is provided from the injection molding machine 10 side without calculating or managing the skill level of the worker. Accordingly, it is possible to change the advice based on the current operation even without identifying who the worker is or what the skill level of the worker is.

Although the embodiment of the present invention has been described above, the technical scope of the present invention is not limited to the above embodiment.

For example, in the above embodiment, in a case where the operation status of the worker is a status in which a specific operation is repeatedly performed, the advice information according to the status is displayed. In addition, in a case where the operation status of the worker is a status in which the time required for a specific operation exceeds a reference, advice information according to the status is displayed. However, these may be considered as follows. In a case where the operation status of the worker is a status presumed to indicate hesitation of the worker, the advice information for eliminating the hesitation is displayed.

In addition, in the above embodiment, the operation of changing the setting value of the specific setting item is assumed and described as the specific operation, but the specific operation is not limited thereto.

The specific operation may include work such as a setup work. Alternatively, the specific work may include work in which the setup work is finely divided, such as the mold attachment and the purging work.

The specific operation may include work performed between molding cycles in a case where a defective product is produced. Repeating a molding cycle (work to check whether or not a defect occurs after the work) from the work can be determined as indicating a low skill level, and taking a long time can also be determined as indicating a low skill level depending on the case.

Further, in the above embodiment, all the functions of the information providing device 400 are realized by the device in the injection molding machine 10, but the present invention is not limited thereto.

For example, some functions of the information providing device 400 may be realized by a terminal device such as a PC, a smartphone, or a tablet connected to the injection molding machine 10 via a communication line. Specifically, the function of determining the advice information of the operation receiving unit 410, the determination unit 420, and the display control unit 430 may be realized by the device in the injection molding machine 10. Then, the function of displaying the advice information of the display control unit 430 may be realized by the terminal device. In such a configuration, the device in the injection molding machine 10 is provided with a function of transmitting the advice information to the terminal device. In addition, a function of receiving the advice information from the device in the injection molding machine 10 is provided in the terminal device. In this case, the function of transmitting the advice information of the device in the injection molding machine 10 is an example of an output unit that outputs advice information. The function of receiving the advice information in the terminal device is an example of an acquisition unit that acquires the advice information. The function of displaying the advice information in the terminal device is an example of an output unit that outputs the advice information.

Further, the functions of the information providing device 400 may also be realized in a distributed manner by a plurality of devices. The plurality of devices include devices in the injection molding machine 10, terminal devices, server computers, and the like. In this case, any device may realize any function. For example, it is conceivable that the plurality of devices may perform processing as follows. First, the device in the injection molding machine 10 determines the operation status of the worker. In this case, this function of the device in the injection molding machine 10 is an example of an acquisition unit that acquires the operation status. Next, the device in the injection molding machine 10 transmits the operation status to the server computer. Next, the server computer receives the operation status. In this case, this function of the server computer is also an example of an acquisition unit that acquires the operation status. Next, the server computer determines advice information for providing advice according to the operation status. Next, the server computer transmits the advice information to the terminal device. In this case, the function of transmitting the advice information of the server computer is an example of an output unit that outputs advice information. Next, the terminal device receives the advice information. Finally, the terminal device displays the advice information on the display screen. In this case, the function of displaying the advice information of the terminal device is also an example of the output unit that outputs the advice information.

In addition, the above embodiment is applied to the work in the injection molding machine 10, but is not limited thereto. The above embodiment may be applied to work in peripheral units other than the injection molding machine 10. Here, examples of the peripheral unit include a temperature controller, a resin dryer, a crusher, a take-out machine, and the like.

It should be understood that the invention is not limited to the above-described embodiment, but may be modified into various forms on the basis of the spirit of the invention. Additionally, the modifications are included in the scope of the invention.

What is claimed is:

1. A molding supporting device comprising:
an acquisition unit that acquires an operation status of an operation currently performed by a worker on the molding supporting device; and
an output unit that outputs advice information that provides advice according to the operation status acquired by the acquisition unit.

2. The molding supporting device according to claim 1, further comprising:
an operation receiving unit that receives the operation of the worker.

3. The molding supporting device according to claim 2,
wherein the operation receiving unit receives an operation of the worker on a control device on an operation screen displayed on a display unit.

4. The molding supporting device according to claim 1,
wherein the operation status includes a status related to a procedure of the operation and a status related to a time of the operation.

5. The molding supporting device according to claim 4,
wherein the status related to the procedure of the operation includes a status in which a specific operation is repeatedly performed and a status in which an order of a specific operation and another specific operation is incorrect.

6. The molding supporting device according to claim 5,
wherein in a case where the status related to the procedure of the operation is the status in which the specific operation is repeatedly performed, the output unit outputs the advice information related to another operation other than the specific operation.

7. The molding supporting device according to claim 6,
wherein in a case where the specific operation is an operation of changing a setting value of a specific setting item, the advice information is information related to existence of another setting item other than the specific setting item.

8. The molding supporting device according to claim 6,
wherein in a case where the specific operation is an operation of changing a setting value of a specific setting item, the advice information is information related to an effect of changing a setting value of another setting item other than the specific setting item.

9. The molding supporting device according to claim 4,
wherein the status related to the time of the operation includes a status in which a time required or taken for a specific operation exceeds a reference and a status in which a time required from a specific operation to another specific operation exceeds the reference.

10. The molding supporting device according to claim 9,
wherein in a case where the status related to the time of the operation is the status in which the time required or taken for the specific operation exceeds the reference, the output unit outputs the advice information related to a defect of the specific operation.

11. The molding supporting device according to claim 10,
wherein in a case where the specific operation is an operation of setting a setting value of a specific setting item, the advice information is information related to an error in a setting procedure of the setting value of the specific setting item or an excess or deficiency of a setting item in the specific setting item.

12. The molding supporting device according to claim 1,
wherein the output unit outputs the advice information that is added value for the worker in a case where the operation status is not a status in which a specific operation is repeatedly performed and is not a status in which a time required for the specific operation exceeds a reference.

13. The molding supporting device according to claim 12,
wherein the advice information is information related to a function not used by the worker or an operation that is effective among operations performed by the worker.

14. The molding supporting device according to claim 5,
wherein the specific operation includes an operation of changing a setting value of a specific setting item, setup work or work constituting the setup work, and work performed between molding cycles in a case where a defective product occurs.

15. The molding supporting device according to claim 1,
wherein in a case where the operation status is a status presumed to indicate hesitation of the worker, the output unit outputs the advice information for eliminating the hesitation.

16. The molding supporting device according to claim 1,
wherein the acquisition unit further acquires an operation content of the operation currently performed by the worker on the molding supporting device, and
the output unit outputs the advice information that further provides advice according to the operation content acquired by the acquisition unit.

17. The molding supporting device according to claim 16,
wherein the output unit outputs the operation content or the advice information for a phenomenon currently occurring which is estimated from the operation content.

18. A molding supporting device comprising:
an acquisition unit that acquires advice information that provides advice according to an operation status of an operation currently performed by a worker on the molding supporting device; and
an output unit that outputs the advice information acquired by the acquisition unit.

19. A molding supporting system comprising:
an acquisition unit that acquires an operation status of an operation currently performed by a worker on a molding supporting device; and
an output unit that outputs advice information that provides advice according to the operation status acquired by the acquisition unit.
